(19) United States
(12) Patent Application Publication
(10) Pub. No.: US 2021/0129602 A1
(43) Pub. Date: May 6, 2021

(54) TIRE PRESSURE GAUGE

(71) Applicant: JINDAI AUTO SUPPLIES CO., LTD, Changhua County (TW)

(72) Inventors: JUI MENG HUANG, Changhua County (TW); YEN CHUN HUANG, Changhua County (TW); CHANG YU HUANG, Changhua County (TW)

(21) Appl. No.: 17/089,697

(22) Filed: Nov. 4, 2020

(30) Foreign Application Priority Data
Nov. 4, 2019 (TW) 108214556

(51) Int. Cl. B60C 23/04

(52) U.S. Cl. CPC B60C 23/0496

(57) ABSTRACT

A tire pressure gauge includes a first tube having a first end secured to a connector; a joining member having a first end secured to a second end of the first tube; a check valve in the joining member and including and air outlet and an air inlet configured to be in fluid communication between the first tube and the air outlet; a spring biased pressure relief device projecting out of the joining member; a second tube threadedly secured to a second end of the joining member; a plunger in a first end of the second tube; a compression spring in the second tube and biased between the plunger and a second end of the second tube; and a rod-shaped measuring device through the compression spring, the measuring device having a first end secured to the plunger and a second end extending out of the second tube.

### BACKGROUND OF THE INVENTION

### 1. Field of the Invention

The invention relates to pressure gauges and more particularly to a tire pressure gauge having improved characteristics.

### 2. Description of Related Art

A conventional tire pressure gauge comprises a first housing adapted for coupling with a valve stem of a tire. A valve pressure indicator is secured within a second housing. The second cylindrical housing couples with the first cylindrical housing. The valve pressure indicator has a needle extending outwardly therefrom. The needle extends through the first cylindrical housing to engage a contact point of the valve stem of the tire. A battery is provided in a third housing. The third cylindrical housing couples with the second cylindrical housing. The battery has wiring extending outwardly therefrom to electrically connect to the valve pressure indicator. A transmitter is secured within a cylindrical housing. The fourth cylindrical housing couples with the third cylindrical housing. The transmitter has a pair of wires in which one wire extends outwardly therefrom to electrically connect to the battery and the other wire electrically connects to the valve pressure indicator.

While the device enjoys its success in the market, continuing improvements in the exploitation of tire pressure gauge of this type are constantly being sought.

### SUMMARY OF THE INVENTION

It is therefore one object of the invention to provide a tire pressure gauge comprising a connector configured to secure to a valve of a tire to be in fluid communication with an interior of the tire; a first tube having a first end secured to the connector; a joining member having a first end secured to a second end of the first tube; a check valve disposed in the joining member and including and air outlet and an air inlet configured to be in fluid communication between the first tube and the air outlet; a pressure relief device including an exposed, hollow pressure relief stem having a mounting member secured to the joining member, at least one pressure relief opening laterally disposed through the pressure relief stem, a first compression spring disposed in the pressure relief stem, and a trigger having a button disposed externally of the pressure relief stem, a shank passing through the first compression spring, and a port disposed in the joining member and configured to be in fluid communication with the air outlet wherein the port is closed in a first position; a second tube having a first end threadedly secured to a second end of the joining member; a plunger disposed in the first end of the second tube; a second compression spring disposed in the second tube and having a first end urging against the plunger and a second end urging against a second end of the second tube; and a rod-shaped measuring device disposed through the second compression spring, the rod-shaped measuring device having a first end secured to the plunger and a second end extending out of the second tube wherein the second compression spring includes a plurality of pressure markings.

The above and other objects, features and advantages of the invention will become apparent from the following detailed description taken with the accompanying drawings.

### BRIEF DESCRIPTION OF THE DRAWINGS

FIG. 1 is a side elevation of a tire pressure gauge according to the invention;

FIG. 2 is a longitudinal sectional view of the tire pressure gauge;

FIG. 3 is a view similar to FIG. 2 showing the rod-shaped measuring device being pulled rearward in a pressure measuring operation; and

FIG. 4 is a view similar to FIG. 3 showing the rod-shaped measuring device moving forward to return to its original position after pressure in the tire has been relieved.

### DETAILED DESCRIPTION OF THE INVENTION

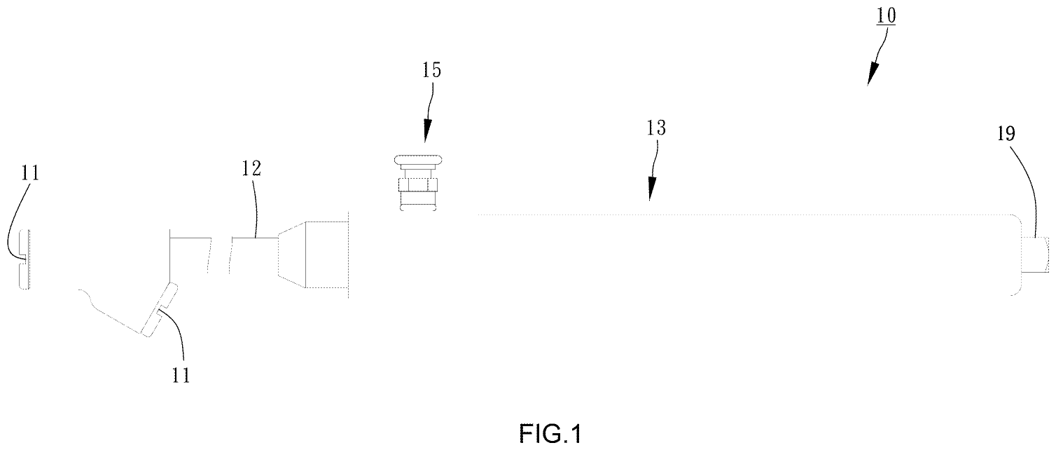

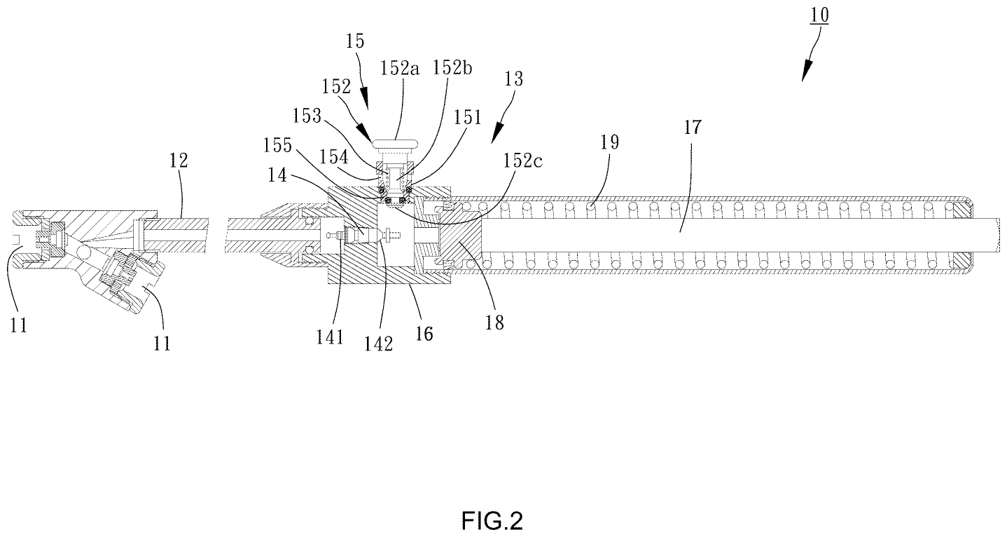

Referring to FIGS. 1 to 4, a tire pressure gauge 10 in accordance with the invention comprises the following components two connectors 11 configured to join a valve of a tire and configured to be in fluid communication with an interior of a tire; a first tube 12 having one end secured to the connectors 11; a joining member 16 having one end secured to the other end of the first tube 12; a check valve 14 disposed in the joining member 16 and including an air inlet 141 configured to be in fluid communication with the first tube 12, and an air outlet 142 communicating with the air inlet 141; a pressure relief device 15 including an exposed, hollow pressure relief stem 151 having a mounting member 155 secured to the joining member 16, a plurality of pressure relief openings 154 laterally disposed through the pressure relief stem 151, a first compression spring 153 disposed in the pressure relief stem 151, and a trigger 152 having a button 152a disposed externally of the pressure relief stem 151, a shank 152b passing through the first compression spring 153, and a port 152c disposed in the joining member 16 and configured to be in fluid communication with the air outlet 142, the trigger 152 being a spring biased trigger; a second tube 13 having one end threadedly secured to the other end of the joining member 16; a plunger 18 disposed in one end of the second tube 13; a second compression spring 19 disposed in the second tube 13 and having one end urging against the plunger 18 and the other end urging against the other end of the second tube 13; and a rod-shaped measuring device 17 disposed through the second compression spring 19 and extending rearward out of the second tube 13, the rod-shaped measuring device 17 having one end secured to the plunger 18 and pressure markings. The port 152c is closed when the trigger 152 is not activated.

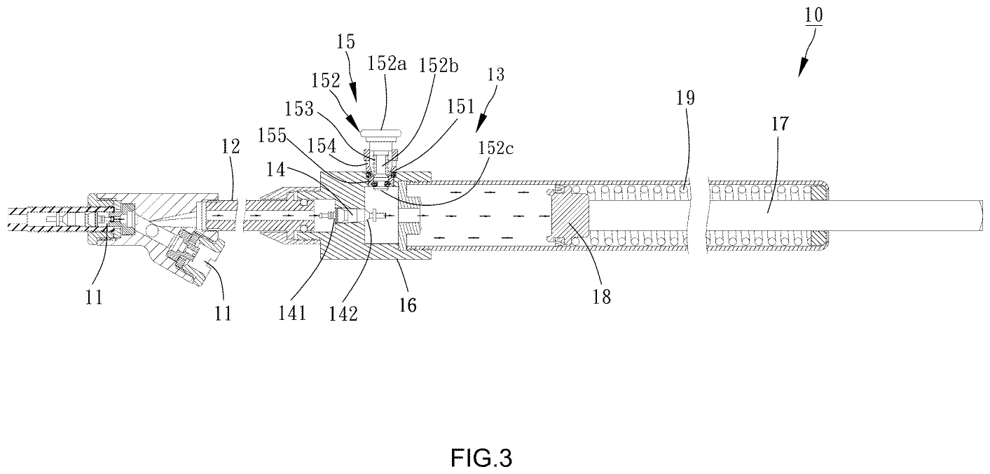

Operations of the Invention are discussed below. As shown in FIG. 3 specifically, a user may attach one of the connectors 11 to a valve of a tire. Pressurized air in the tire flows to the joining member 16 through the first tube 12. And in turn, the air pushes both the plunger 18 and the rod-shaped measuring device 17 rearward with the second compression spring 19 compressed. The rearward movements of both the plunger 18 and rod-shaped measuring device 17 stop when a balance is reached between the force of the air in the second tube 13 exerted on the plunger 18 and the compressed force of the second compression spring 19 exerted opposite in direction on the plunger 18. A user may see the pressure markings on the exposed portion of the rod-shaped measuring device 17 to precisely measure pressure of the tire. It is understood that the air in the joining member 16 is trapped since the air is not allowed to flow backward to the air inlet 141 and the port 152c is closed.

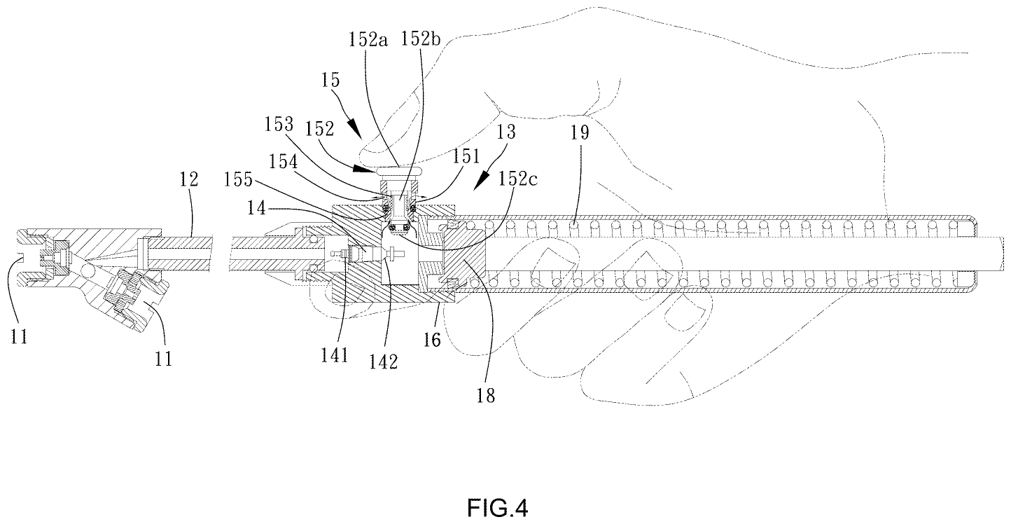

As shown in FIG. 4 specifically, in case of the air in the tire exceeds a preset value or after finishing the pressure measurement, the user may press the button 152a to compress the first compression spring 153. And in turn, the port 152c is open. As a result, the pressure in the tire is relieved by allowing the pressurized air in the tire, the first tube 12, and the joining member 16 to flow from the pressure relief openings 154 out of the tire pressure gauge 10.

While the invention has been described in terms of preferred embodiments, those skilled in the art will recognize that the invention can be practiced with modifications within the spirit and scope of the appended claims.

What is claimed is:

1. A tire pressure gauge comprising:
a connector configured to secure to a valve of a tire to be in fluid communication with an interior of the tire;
a first tube having a first end secured to the connector;
a joining member having a first end secured to a second end of the first tube;
a check valve disposed in the joining member and including and air outlet and an air inlet configured to be in fluid communication between the first tube and the air outlet;
a pressure relief device including an exposed, hollow pressure relief stem having a mounting member secured to the joining member, at least one pressure relief opening laterally disposed through the pressure relief stem, a first compression spring disposed in the pressure relief stem, and a trigger having a button disposed externally of the pressure relief stem, a shank passing through the first compression spring, and a port disposed in the joining member and configured to be in fluid communication with the air outlet;
a second tube having a first end threadedly secured to a second end of the joining member;
a plunger disposed in the first end of the second tube;
a second compression spring disposed in the second tube and having a first end urging against the plunger and a second end urging against a second end of the second tube; and
a rod-shaped measuring device disposed through the second compression spring, the rod-shaped measuring device having a first end secured to the plunger and a second end extending out of the second tube wherein the second compression spring includes a plurality of pressure markings;
wherein the port is closed in a first position or open in a second position.
